(19) United States
(12) Patent Application Publication
(10) Pub. No.: US 2005/0160021 A1
(43) Pub. Date: Jul. 21, 2005

(54) Real-time price studies

(76) Inventors: Kevin A. Nesmith, Austin, TX (US); Jason W. Abshire, Austin, TX (US); John Bunda, Austin, TX (US); Thomas Dixon, Austin, TX (US); Erik E. Fierce, Austin, TX (US); Todd W. Gruben, Cedar Park, TX (US); Sandi Lester, Austin, TX (US); Jason C. Mongaras, Austin, TX (US); Omar Salinas, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/016,267

(22) Filed: Dec. 17, 2004

Related U.S. Application Data
(63) Continuation of application No. 09/460,045, filed on Dec. 13, 1999.

(51) Int. Cl. G06F 17/60

(52) U.S. Cl. 705/35

(57) ABSTRACT

An improved method and system for computerized trading of securities in which order preferences for securities are entered by a user and are stored on a computer system for future use as default values in response to the user placing an order. The time that it takes to complete an order may be reduced through the use of previously selected order preferences being displayed to the user in the order placement window. In another method for order entry, a user may specify a price-point and a security transaction flag option for a security transaction (e.g., buy, sell, sell short, stop loss, stop limit, sell to open, sell to close, buy to open, buy to close) on a price chart window for a particular security. The computer system monitors the price fluctuation of the particular security, and takes the specified security transaction in response to the specified price-point being reached. In another embodiment, real-time results for user-selected studies are utilized as a tool for a user to decide on a price-point at which to take a particular security transaction on a particular security.

### PRIORITY CLAIM

This application is a divisional of U.S. patent application Ser. No. 09/460,045 entitled “Computerized Method and System for Trading of Securities,” filed Dec. 13, 1999.

### BACKGROUND OF THE INVENTION

1. Field of the Invention

The present invention generally relates to computer software. More particularly, the present invention relates to computer-implemented trading of securities.

2. Description of the Related Art

The securities trading industry has burgeoned since the advent of the Internet. Many companies offer securities trading services through a variety of automated methods, such as through a telephone or a computer system. The placement of orders to buy or sell securities may be done through the use of an order entry screen on a computer system. Some of the elements of the order entry screen may include: a security transaction, a security symbol, a number of shares to be traded, a dollar amount, a limit price, a trailing stop price, and a stop loss price. As used herein, a “security transaction” may be one of the following: buy, sell, sell short, stop loss, stop limit, sell to open, sell to close, buy to open, buy to close. Existing order entry screens for placing securities orders require the user to enter all of the information for the order, each time an order is placed. In order to reduce the time it takes the user to submit a securities order for execution, it is desirable to provide a method for storing user-specified order preferences for securities and using those preferences to automatically populate an order entry screen.

In addition to order entry screens, price charts have also become popular tools with securities traders. A price chart for a particular security is typically a graph of the price movements for the particular security over a period of time. Price charts may be used to recognize trends in the direction and volatility of a particular security. Existing trading systems typically have price charts available to the user, but they do not allow the user to specify a price point, directly on the price chart, at which the user wishes to conduct a security transaction (e.g., buy, sell, sell short, stop loss, stop limit, sell to open, sell to close, buy to open, buy to close). It is desirable, in the interest of reducing the amount of time it takes the user to submit a securities order for execution, to provide a method to allow the user to specify a price point, directly on the price chart, at which the user wishes to conduct a security transaction.

There are many methods of analyzing historical securities data. These methods may be referred to as “studies”. Some examples of studies are: a candlestick study, a price patterns study, a resistance lines study, and a triangulation study. Another name for candlestick study is candle study. Many companies offer data over various historical time periods that utilize the concepts of these studies. To make these studies more useful in the time-critical world of day-trading, it is desirable to provide a method for presenting data from these studies in real-time, rather than strictly in historical time. Additionally, it is desirable to provide a method to allow the user to specify a price point, directly on the presentation of real-time study data, at which the user wishes to conduct a security transaction.

### SUMMARY OF THE INVENTION

The present invention provides various embodiments of an improved method and system for computerized trading of securities.

In one embodiment, order preferences for securities are entered by a user and are stored on a computer system for future use as default values in response to the user placing an order. The user may adjust any or all of the default values at the time of order placement. The time that it takes to complete an order may potentially he reduced through the use of previously selected order preferences being displayed to the user in the order placement window.

In another embodiment, a user may specify a price-point on a price chart window for a particular security. For the specified price-point, the user may specify a security transaction flag option indicating the security transaction (e.g., buy, sell, sell short, stop loss, stop limit, sell to open, sell to close, buy to open, buy to close) to be taken in response to the specified price-point being reached. The computer system then monitors the price fluctuation of the particular security, and takes the specified security transaction in response to the specified price-point being reached.

In another embodiment, real-time results for user-selected studies are utilized as a tool for a user to decide on a price-point at which to initiate a particular security transaction on a particular security. The user is presented with a list of studies from which to choose.

For the user-selected studies, the user may further enter values for any parameters required for the studies. The real-time results for the user-selected studies are categorized into one of three categories: buy, sell, and inconclusive. Those studies in the list of studies not selected by the user are placed in a fourth category: inactive.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 is a network diagram of a wide area network which is suitable for implementing various embodiments;

FIG. 2 is an illustration of a typical computer system which is suitable for implementing various embodiments;

FIG. 3 is a flowchart illustrating the collection of security-specific order preferences according to one embodiment;

FIG. 4 is a flowchart illustrating the collection of generic order preferences according to one embodiment;

FIG. 5 is an illustration of a security-specific order preferences window which is suitable for implementing various embodiments;

FIG. 6 is an illustration of a generic order preferences window which is suitable for implementing various embodiments;

FIG. 7 is a flowchart illustrating a method of submitting an order for execution through the use of an order placement window according to one embodiment;

FIG. 8 is a flowchart illustrating a method of submitting an order for execution through the use of a price chart window according to one embodiment;

FIG. 9 is a flowchart illustrating a method of submitting an order for execution through the use of real-time results for user-selected studies according to one embodiment;

FIG. 10 is an illustration of a single pair of resistance lines according to one embodiment;

FIG. 11 is an illustration of a pair of candlesticks according to one embodiment;

FIG. 12 is a flowchart illustrating a study details window according to one embodiment;

FIG. 13 is a flowchart illustrating the four categories (buy, sell, inconclusive, inactive) into which the studies may be grouped according to one embodiment;

FIG. 14 is a flowchart illustrating a method of submitting an order for execution through the use of a user-specified price point according to one embodiment;

FIG. 15 is a flowchart illustrating a method of submitting an order for execution through the use of real-time results for a study according to one embodiment;

FIG. 16 is an illustration of a price patterns study window which is suitable for implementing various embodiments;

FIG. 19 is an illustration of a security-specific order placement window which is suitable for implementing various embodiments;

FIG. 20 is an illustration of a price chart window which is suitable for implementing various embodiments;

FIG. 21 is an illustration of a candle studies window which is suitable for implementing various embodiments;

FIG. 22 is an illustration of a parameter window for the candle studies window which is suitable for implementing various embodiments;

FIG. 23 is an illustration of a resistance line study window with a daily time interval which is suitable for implementing various embodiments;

FIG. 24 is an illustration of a resistance line study window with a 5 minute time interval which is suitable for implementing various embodiments; and

FIG. 25 is an illustration of a buy/sell indicator window which is suitable for implementing various embodiments.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

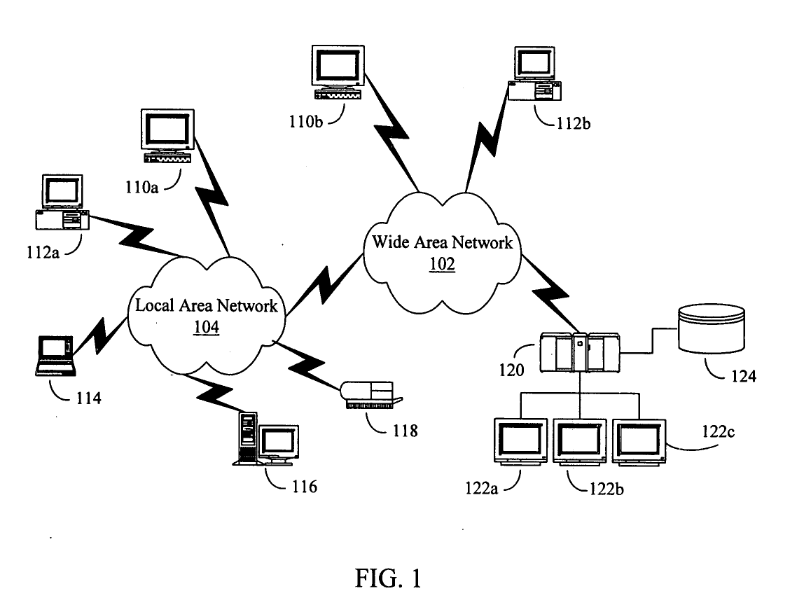

FIG. 1: Wide Area Network

FIG. 1 illustrates a wide area network (WAN) according to one embodiment. WAN 102 is a network that spans a relatively large geographical area. The Internet is an example of WAN 102. WAN 102 typically includes a plurality of computer systems which are interconnected through one or more networks. Although one particular configuration is shown in FIG. 1, WAN 102 may include a variety of heterogeneous computer systems and networks which are interconnected in a variety of ways and which run a variety of software applications.

One or more local area networks (LANs) 104 may be coupled to WAN 102. A LAN 104 is a network that spans a relatively small area. Typically, a LAN 104 is confined to a single building or group of buildings. Each node (i.e., individual computer system or device) on a LAN 104 preferably has its own CPU with which it executes programs, and each node is also able to access data and devices anywhere on the LAN 104. The LAN 104 thus allows many users to share devices (e.g., printers) as well as data stored on file servers. The LAN 104 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves).

Each LAN 104 includes a plurality of interconnected computer systems and optionally one or more other devices: for example, one or more workstations 110a, one or more personal computers 112a, one or more laptop or notebook computer systems 114, one or more server computer systems 116, and one or more network printers 118. As illustrated in FIG. 1, an example LAN 104 may include one of each of computer systems 110a, 112a, 114, and 116, and one printer 118. The LAN 104 may be coupled to other computer systems and/or other devices and/or other LANs 104 through WAN 102.

One or more mainframe computer systems 120 may be coupled to WAN 102. As shown, the mainframe 120 may be coupled to a storage device or file server 124 and mainframe terminals 122a, 122b, and 122c. The mainframe terminals 122a, 122b, and 122c may access data stored in the storage device or file server 124 coupled to or included in the mainframe computer system 120.

WAN 102 may also include computer systems which are connected to WAN 102 individually and not through a LAN 104: as illustrated, for purposes of example, a workstation 110b and a personal computer 112b. For example, WAN 102 may include computer systems which are geographically remote and connected to each other through the Internet.

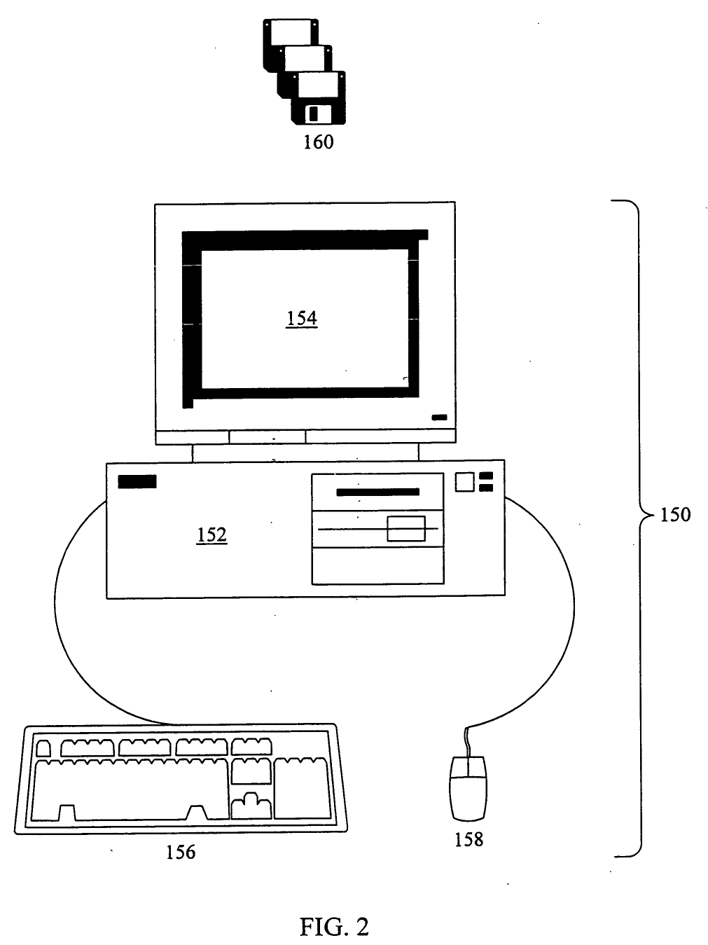

FIG. 2: Typical Computer System

FIG. 2 illustrates a typical computer system 150 which is suitable for implementing various embodiments of a system and method for computerized trading of securities. Each computer system 150 typically includes components such as a CPU 152 with an associated memory medium such as floppy disks 160. The memory medium may store program instructions for computer programs, wherein the program instructions are executable by the CPU 152. The computer system 150 may further include a display device such as a monitor 154, an alphanumeric input device such as a keyboard 156, and a directional input device such as a mouse 158. The computer system 150 may be operable to execute the computer programs to implement trading of securities as described herein.

The computer system 150 preferably includes a memory medium on which computer programs according to various embodiments may be stored. The term “memory medium” is intended to include an installation medium, e.g., a CD-ROM, or floppy disks 160, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. Also, the computer system 150 may take various forms, including a personal computer system, mainframe computer system, workstation, network appliance, Internet appliance, personal digital assistant (PDA), television system or other device. In general, the term “computer system” can be broadly defined to encompass any device having a processor which executes instructions from a memory medium.

The memory medium preferably stores a software program or programs for trading of securities as described herein. The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), browser-based applications (e.g., Java applets), traditional programs, or other technologies or methodologies, as desired. A CPU, such as the host CPU 152, executing code and data from the memory medium includes a means for creating and executing the software program or programs according to the methods and/or block diagrams described below.

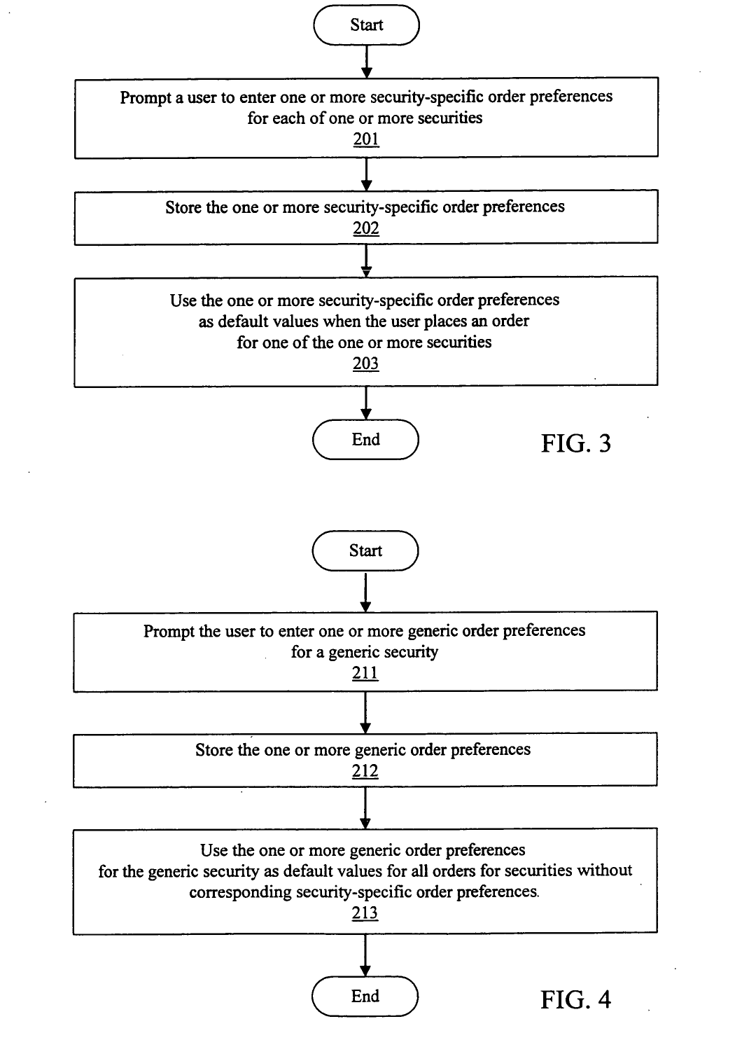

FIG. 3: Security-Specific Order Preferences

FIG. 3 shows an embodiment of the system and method for computerized trading of securities. As shown in FIG. 3, according to one embodiment, a user may be prompted to enter one or more security-specific order preferences for each of one or more securities in step 201. As used herein, an “order preference” is a default value to be used in response to a user placing an order for a security. In step 202, the one or more security-specific order preferences may be stored in a memory on a computer system (e.g., on a user's computer or on a server). In step 203, the one or more security-specific order preferences may be used as default values in response to the user placing an order for one of the one or more securities.

FIG. 4: Generic Order Preferences

FIG. 4 shows an embodiment of the system and method for computerized trading of securities. As shown in FIG. 4, according to one embodiment, a user may be prompted to enter one or more generic order preferences for a generic security in step 211. In step 212, the one or more generic order preferences may be stored in a memory on a computer system. In step 213, the one or more generic order preferences for the generic security may be used as default values for all orders for securities without corresponding security-specific order preferences.

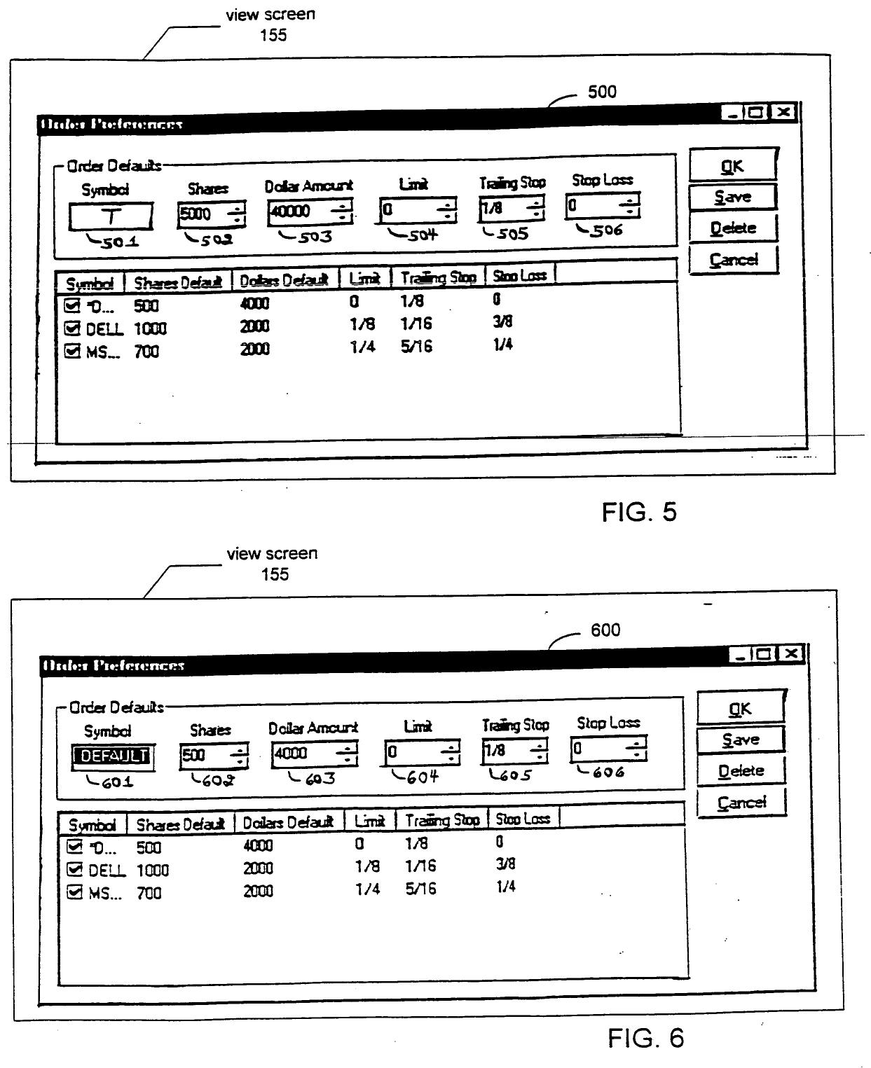

FIG. 5: Security-Specific Order Preferences Window

FIG. 5 illustrates a security-specific order preferences window 500 according to one embodiment. The security-specific order preferences window 500 may be included within a view screen 155. The view screen 155 may be displayed on monitor 154, of FIG. 2. The security-specific order preferences window 500 may include one or more user interface elements, such as a security symbol 501, a number of shares 502, a dollar amount 503, a limit price 504, a trailing stop price 505, and a stop loss price 506. As shown in FIG. 5, the security symbol 501 is “T”, which is the security symbol of AT&T Corporation, the number of shares 502 is 5000 shares, the dollar amount 503 is $40,000, the limit price 504 is $0, the trailing stop price 505 is $0.125, and the stop loss price 506 is $0. As used herein, a “user interface element” is a command, control, or mechanism for a user to input data into a computer program. As used herein, a “limit order” is an order to buy a specified quantity of a security at or below a specified price, or to sell it at or above a specified price. As used herein, a “limit price” is the price specified in a limit order. As used herein, a “trailing stop order” is a stop loss order that follows the prevailing price trend. As used herein, a “trailing stop price” is the price specified in a trailing stop order. As used herein, a “stop loss order” is an order to buy or sell a certain quantity of a certain security if a specified price is reached or passed, wherein the specified price is below the current market price and the order is to sell. As used herein, a “stop loss price” is the price specified in a stop loss order.

In some embodiments, the user need not complete all fields on window 500 for each security. For example, specifying a number of shares 502 may be sufficient in lieu of specifying a dollar amount 503.

Alternatively, the security-specific order preferences window 500 may include additional user interface elements (not shown), such as a “lot indicator” for the minimum amount of the lot which must be bought or sold. As used herein, a “lot” is a group of items which are bought or sold together. For example, if the user specifies the “lot indicator” to be 25% then only if at least 25% of the order can be filled will an offer to buy/sell from the user be accepted. The “lot indicator” may have a default value (i.e., 100%) to be used if the user does not specify a value.

Another user interface element (not shown) may be a “limit price indicator” for the limit price 504. The “limit price indicator” may require a pair of prices (a maximum price and a minimum price) and a percentage of the difference between the two prices. Two examples of maximum and minimum price pairs are the bid and ask price of a security and the 52-week high and 52-week low price of a security. As used herein, a “bid” is the highest price any buyer is willing to pay for a given security at a given time. Conversely, an “ask” is the lowest price any seller is willing to accept for a given security at a given time. As used herein, a “52-week high” is the highest price that a given security has traded at in the previous 52 weeks. Similarly, a “52-week low” is the lowest price that a given security has traded at in the previous 52 weeks. The “limit price indicator” may have a default value (i.e., 50%) for the percentage of the difference between the two prices to be used if the user does not specify a percentage. Also, the pair of prices may be identified by a term (i.e., “bid/ask” or “52-week”) or by dollar amounts.

FIG. 6: Generic Order Preferences Window

FIG. 6 illustrates a generic order preferences window 600 according to one embodiment. The generic order preferences window 600 may be included within a view screen 155. The view screen 155 may be displayed on monitor 154, of FIG. 2. The generic order preferences window 600 may include one or more user interface elements, such as a security symbol 601, a number of shares 602, a dollar amount 603, a limit price 604, a trailing stop price 605, and a stop loss price 606. As shown in FIG. 6, the security symbol 601 is “DEFAULT”, which indicates the generic security. Order preferences that are set for the generic security may be used as defaults during order entry for any security not having its own security-specific settings. Also shown in FIG. 6, the number of shares 602 is 500 shares, the dollar amount 603 is $4,000, the limit price 604 is $0, the trailing stop price 605 is $0.125, and the stop loss price 606 is $0.

In some embodiments, the user need not complete all fields on window 600. For example, specifying a number of shares 602 may be sufficient in lieu of specifying a dollar amount 603.

Alternatively, the generic order preferences window 600 may include additional user interface elements as described for FIG. 5 above.

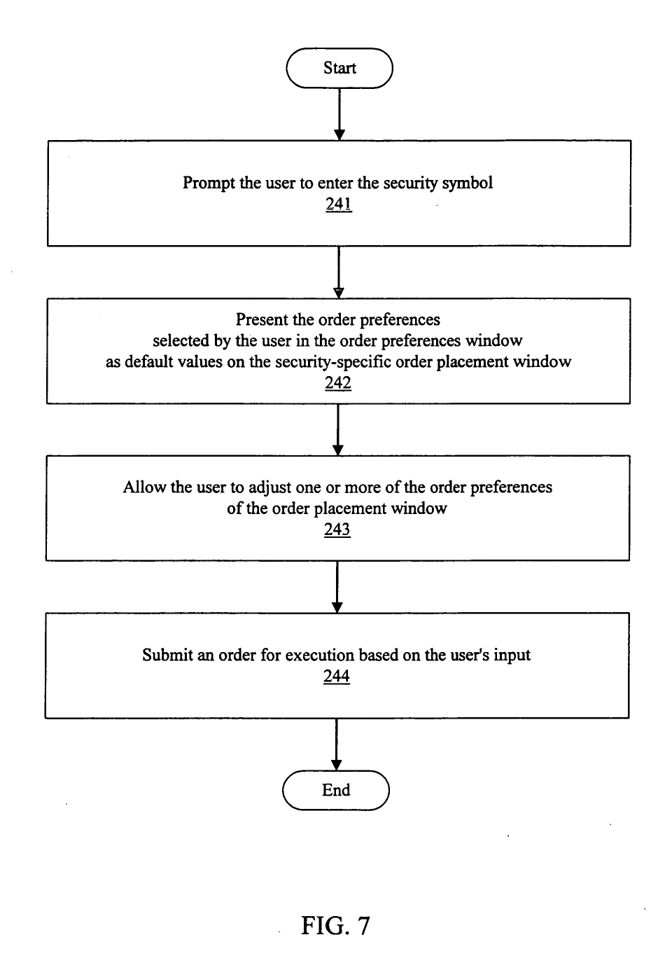

FIG. 7: Submit an Order for Execution—Order Placement Window

FIG. 7 shows steps that may illustrate submitting an order for execution through the use of an order placement window, according to one embodiment. In step 241, the user may be prompted to enter the security symbol. In step 242, the order preferences previously selected by the user in the order preferences window may be presented in the order placement window as default values. By automatically presenting previously selected order preferences based on the security symbol entered, the order entry may be completed relatively rapidly. Speed of order execution is an important aspect for securities trading, particularly for day-trading.

In step 243, the user may be allowed to adjust one or more of the order preferences of the order placement window. In step 244, the order may be submitted for execution, based on the user's input. As used herein, an “order execution” is the completion of an order to buy or sell a security.

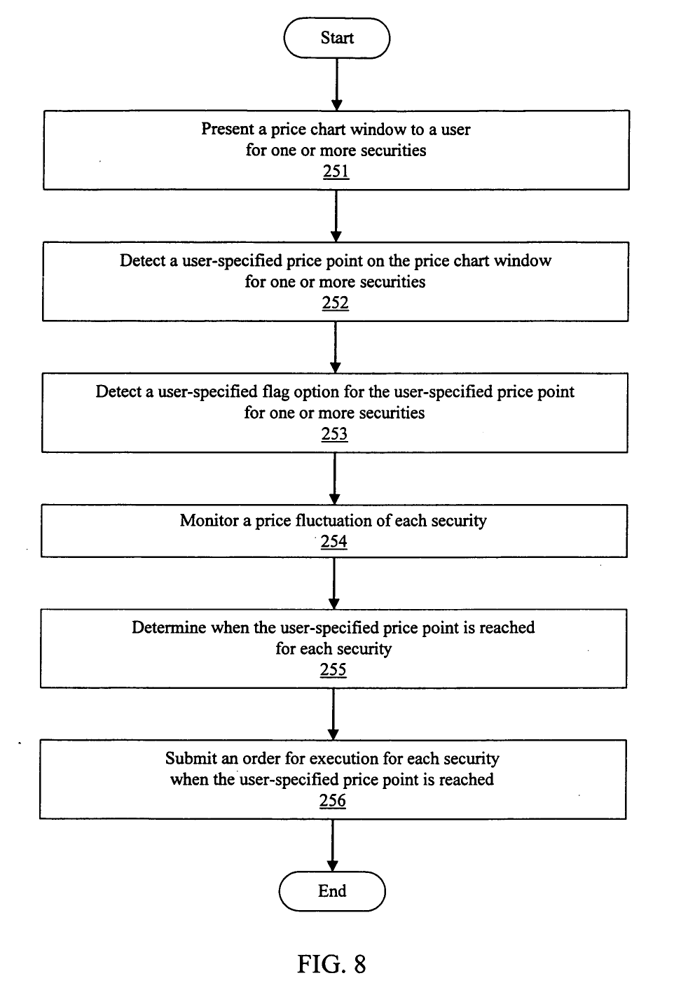

FIG. 8: Submit an Order for Execution—Price Chart Window

FIG. 8 shows steps that may illustrate submitting an order for execution through the use of a price chart window, according to one embodiment. In step 251, the user may be presented with a price chart window for one or more securities. In step 252, the user may specify a price-point on the price chart window, for one or more securities. In step 253, the user may specify a security transaction flag option for the user-specified price-point on the price chart window, for one or more securities. As used herein, a “flag” is a software mark or variable that signals a particular condition or status. As used herein, a “flag option” is the condition or status, such as the values for a security transaction: a buy flag, a sell flag, a sell short flag, a stop loss flag, and a stop limit flag. For example, a “buy flag at $42” indicates the desire of the user to purchase the particular security for which the buy flag has been set, in response to that security beginning trading at $42. In step 254, the price fluctuation of each security may be monitored. In step 255, the point in time at which the user-specified price-point is reached may be determined, for each security. In step 256, the order may be submitted for execution, for each security, in response to the user-specified price-point being reached.

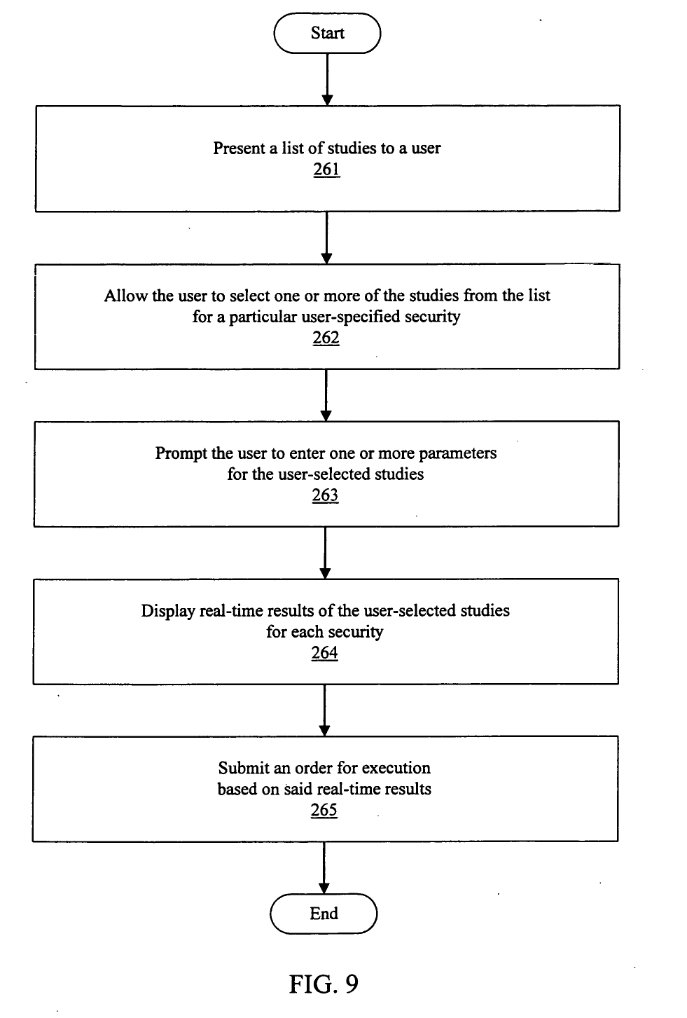

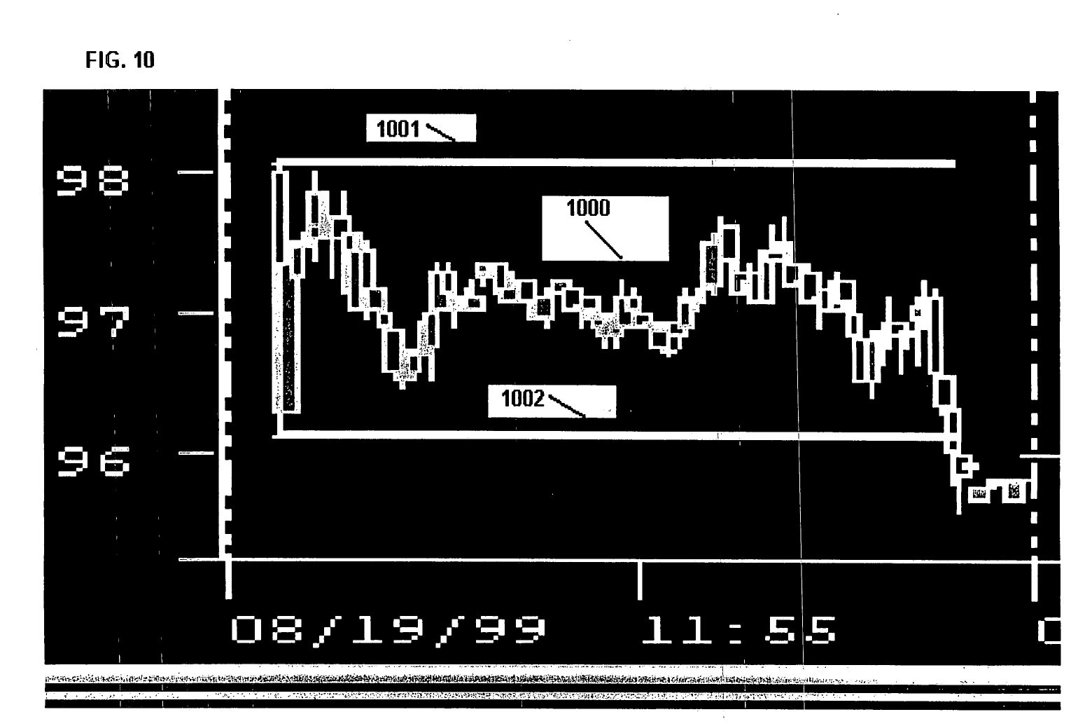

FIG. 9: Submit an Order for Execution—using Real-Time Results for User-Selected Studies

FIG. 9 shows steps that may illustrate submitting an order for execution through the use of real-time results for user-selected studies, according to one embodiment. In step 261, the user may be presented with a list of studies. In step 262, the user may be allowed to select one or more of the studies from the list for a particular user-specified security. In step 263, the user may be prompted to enter one or more parameters for the user-selected studies. In step 264, real-time results of the user-selected studies for each security may be displayed. In step 265, the order may be submitted for execution, based on the real-time results.

FIG. 10: A Single Pair of Resistance Lines

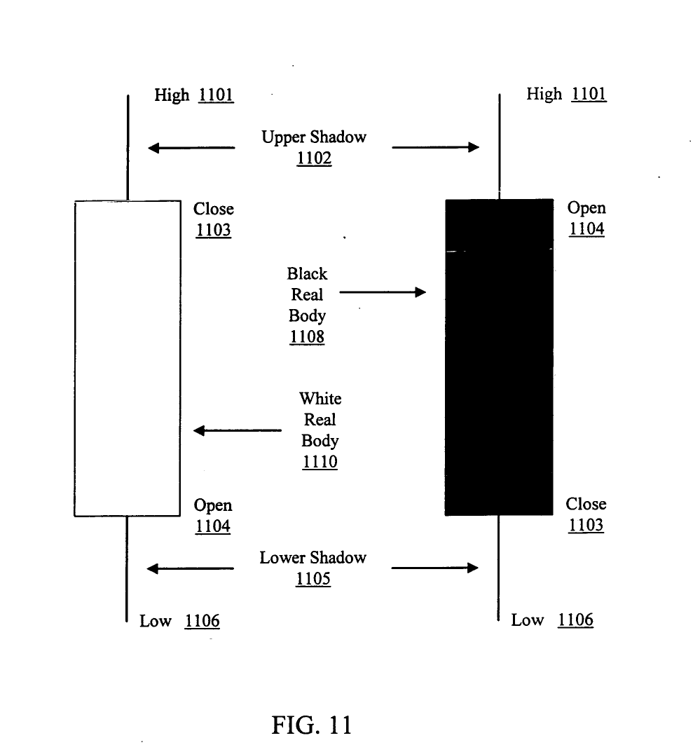

FIG. 10 illustrates a single pair of resistance lines according to one embodiment. As used herein, “resistance” indicates a price level at which rising prices have stopped rising and either moved sideways or reversed direction. The single pair of resistance lines are a subset of the illustration in FIG. 24. In one embodiment, the graph on which the resistance lines are placed may be a candlestick study. A series of candlesticks 1000, one for each time period, may be displayed. For more detail on candlesticks, refer to FIG. 11. An upper resistance line 1001 and a lower resistance line 1002 may be identified. The distance between the upper resistance line 1001 and the lower resistance line 1002 is user-specified. This distance may be stored in a “points for height” parameter. A “cushion around height” parameter may be specified to represent an acceptable price range for the pattern above the upper resistance line 1001 and below the lower resistance line 1002.

The pair of resistance lines 1001 and 1002 may be drawn on the graph in response to the patterns reaching at least a user-specified number of time periods. The user-specified number of time periods may be stored in a “number of bars for width” parameter representing a minimum width measured in candles. If the resistance lines study finds an area of resistance in the graph that is comprised of fewer candles than specified in the “number of bars for width” parameter, then that area of resistance is ignored and no resistance lines are shown. If the price of the security breaks the upper resistance line, then the price of the security will probably increase. If the price of the security breaks the lower resistance line, then the price of the security will probably decrease. Resistance is a highly individual study. Parameters which work for one security will generally not produce satisfactory results for another security. Typically, the larger the price range for the security, the larger the height parameter.

A triangulation study is similar to a resistance lines study. The difference between the triangulation study and the resistance lines study is that the resistance lines are sloped for triangulation and straight for resistance.

FIG. 11: A Pair of Candlesticks

FIG. 11 illustrates a pair of candlesticks according to one embodiment. A candlestick is a graph plotting an open price, a close price, a high price, and a low price for a security for a user-specified time period. In one embodiment, a candlestick is created by following these steps: (a) plot four prices for the user-specified time period (an open price 1104, a close price 1103, a high price 1101, a low price 1106); (b) draw a first horizontal line, using the open price 1104 as the mid-point; (c) draw a second horizontal line, parallel to the first horizontal line, using the close price 1103 as the mid-point; (d) connect a left-side end point of the first horizontal line to a left-side end point of the second horizontal line, completing a third side of a rectangle where a first side of the rectangle is the first horizontal line and a second side of the rectangle is the second horizontal line; (e) connect a right-side end point of the first horizontal line to a right-side end point of the second horizontal line, completing a fourth side of the rectangle. If the open price 1104 for the security for the user-specified time period is higher than the close price 1103 for the security for the user-specified time period, then fill in the rectangle with a dark color (e.g., black, red). Conversely, if the open price 1104 for the security for the user-specified time period is lower than the close price 1103 for the security for the user-specified time period, then fill in the rectangle with a light color (e.g., white, green). From a mid-point of a top side of the rectangle (this mid-point is the open price 1104 when the open price 1104 for the security for the user-specified time period is higher than the close price 1103 for the security for the user-specified time period. Conversely this mid-point is the close price 1103 when the close price 1103 for the security for the user-specified time period is higher than the open price 1104 for the security for the user-specified time period), draw a line to the high price 1101. From a mid-point of a bottom side of the rectangle (this mid-point is the open price 1104 when the open price 1104 for the security for the user-specified time period is lower than the close price 1103 for the security for the user-specified time period. Conversely this mid-point is the close price 1103 when the close price 1103 for the security for the user-specified time period is lower than the open price 1104 for the security for the user-specified time period), draw a line to the low price 1106. The range between the open price 1104 and the close price 1103, which is shown by the rectangle, is referred to as the real body. If the rectangle is filled in with a light color, the rectangle is referred to as a white real body 1110, and conversely, if the rectangle is filled in with a dark color, the rectangle is referred to as a black real body 1108. The range between the top of the real body and the high price 1101 is referred to as an upper shadow 1102. The range between the bottom of the real body and the low price 1106 is referred to as a lower shadow 1105. The candlestick indicates a bullish signal in response to the closing price 1103 being greater than the opening price 1104, and conversely, the candlestick indicates a bearish signal in response to the closing price 1103 being equal to or lower than the opening price 1104.

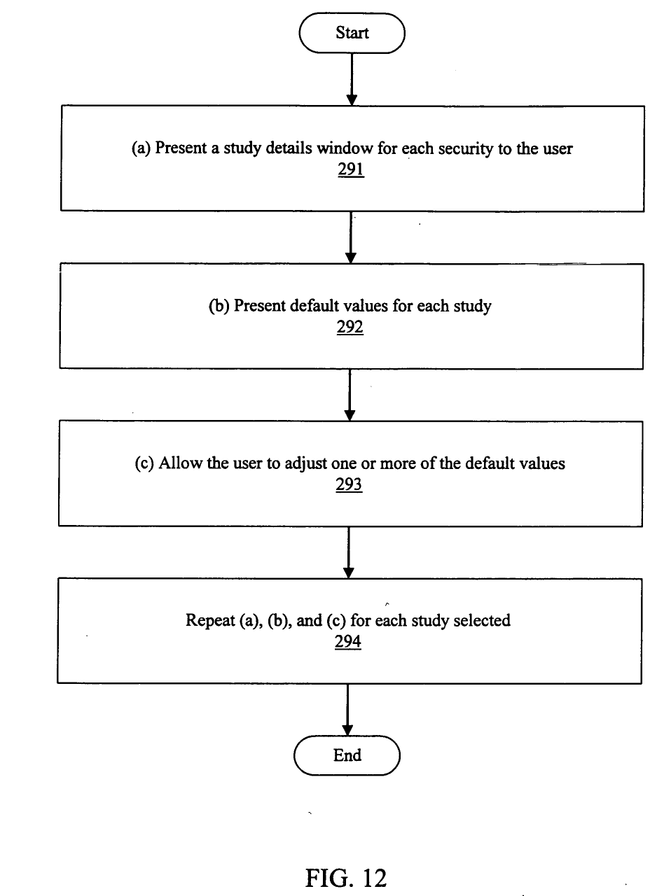

FIG. 12: Study Details Window

FIG. 12 illustrates one embodiment of a method for using a study details window. As shown in FIG. 12, according to one embodiment, in step 291, a study details window may be presented to the user for each security. In step 292, default values for each study may be presented. In step 293, the user may be allowed to adjust one or more of the default values. In step 294, the above may be repeated, for each study selected.

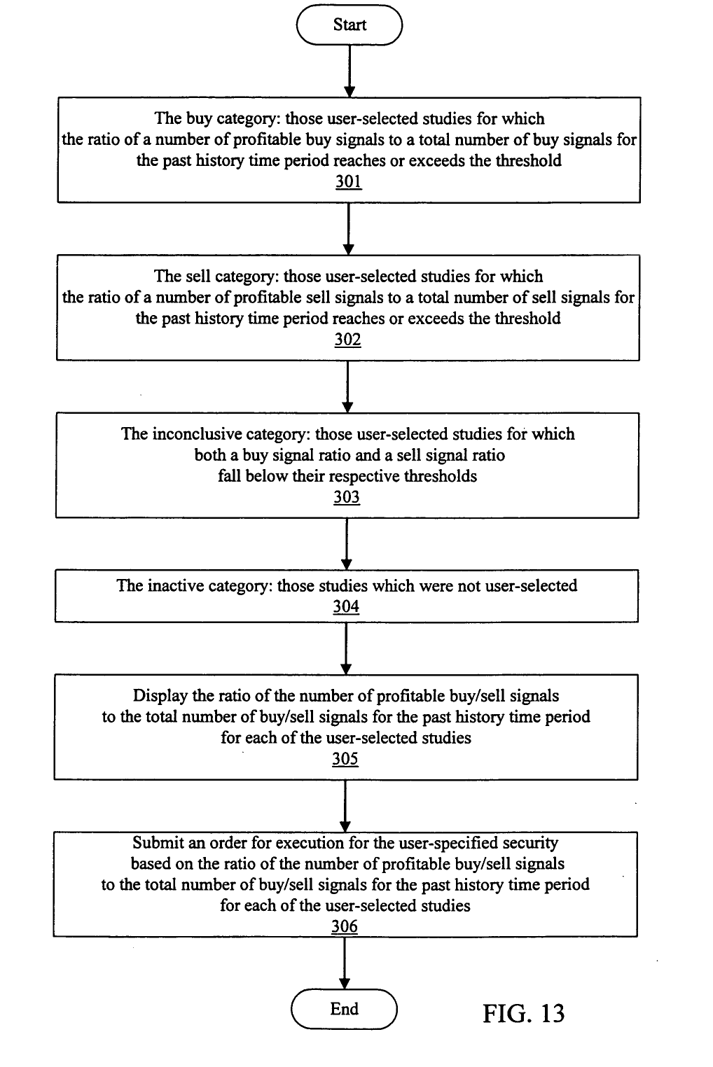

FIG. 13: Four Categories (Buy, Sell, Inconclusive, Inactive)

FIG. 13 shows steps that may illustrate the categories into which the real-time results for user-selected studies may be placed, according to one embodiment. In step 301, the buy category may include user-selected studies for which the ratio of a number of profitable buy signals to a total number of buy signals for the past history time period reaches or exceeds the threshold. As used herein, a “threshold” is a value above which something is true or will take place and below which it is not true or will not take place. As used herein, a “buy signal” is any indication of when it is time to buy a particular security. As used herein, a “sell signal” is any indication of when it is time to sell a particular security. In step 302, the sell category may include user-selected studies for which the ratio of a number of profitable sell signals to a total number of sell signals for the past history time period reaches or exceeds the threshold. In step 303, the inconclusive category may include user-selected studies for which both a buy signal ratio and a sell signal ratio fall below their respective thresholds. In step 304, the inactive category may include those studies which were not user-selected. In step 305, the ratio of the number of profitable buy/sell signals to the total number of buy/sell signals for the past history time period for each of the user-selected studies may be displayed. In step 306, the ratio of the number of profitable buy/sell signals to the total number of buy/sell signals for the past history time period for each of the user-selected studies may be used to determine whether or not to automatically submit an order for execution for the user-specified security.

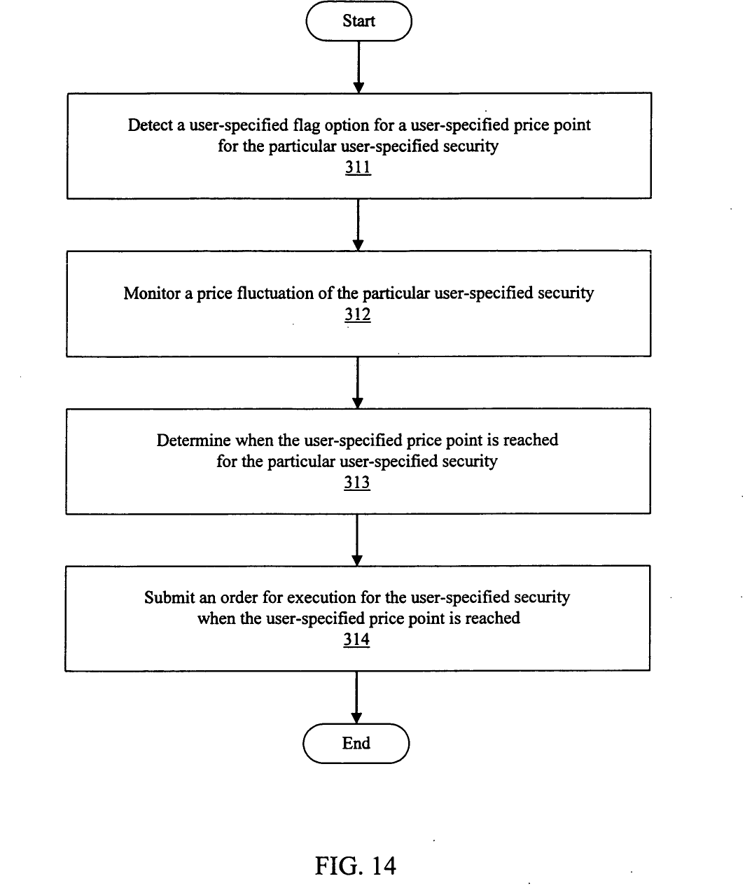

FIG. 14: Submit an Order for Execution—Using a User-Specified Price Point

FIG. 14 shows steps that may illustrate submitting an order for execution through the use of a price chart window, according to one embodiment. In step 311, the user may specify a security transaction flag option for the user-specified price-point on the price chart window, for the particular user-specified security. In step 312, the price fluctuation of the particular user-specified security may be monitored. In step 313, the point in time at which the user-specified price-point is reached may be determined, for the particular user-specified security. In step 314, the order may be automatically submitted for execution, for the particular user-specified security, in response to the user-specified price-point being reached.

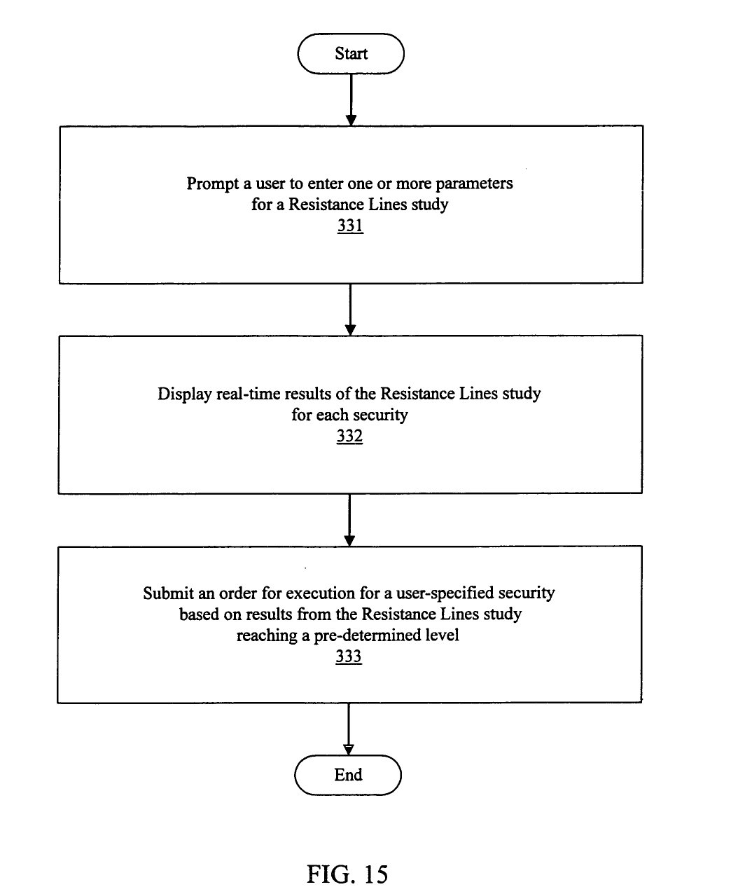

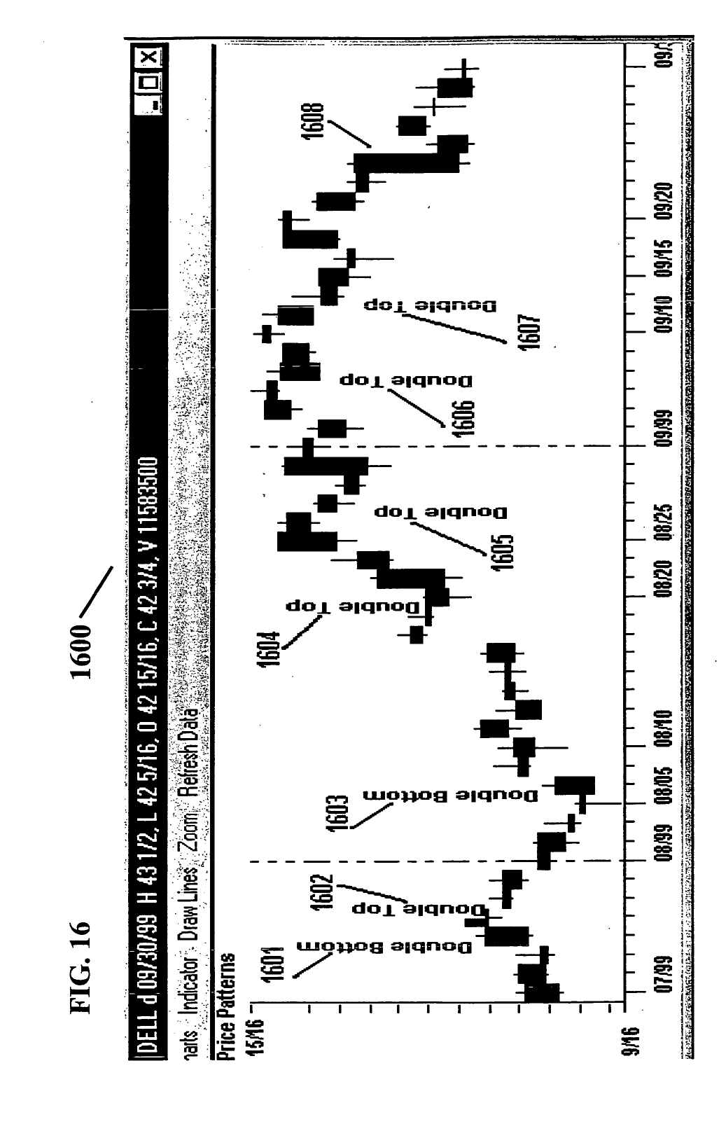

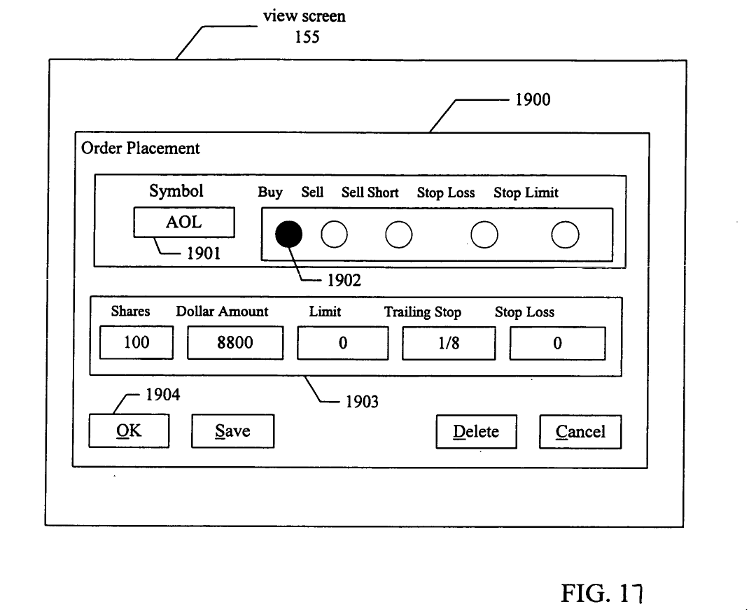

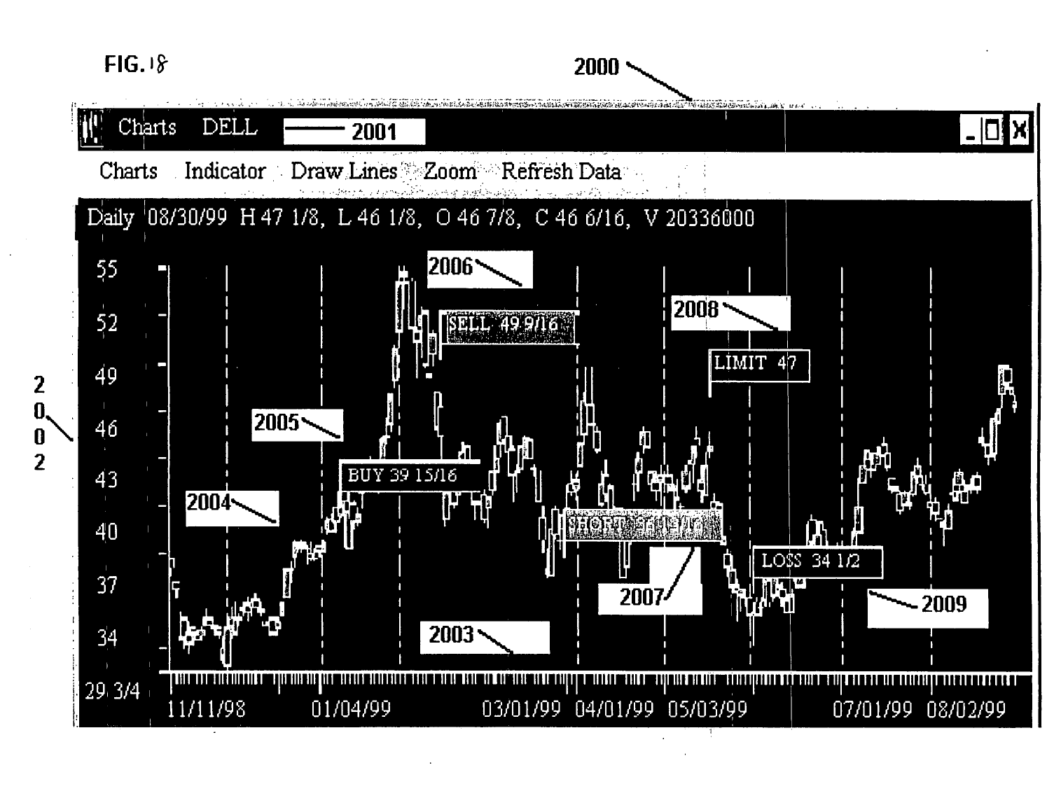

FIG. 15: Submit an Order for Execution—Using Real-Time Results for a Study

FIG. 15 shows steps that may illustrate submitting an order for execution through the use of real-time results for a study, according to one embodiment. In step 331, the user may be prompted to enter one or more parameters for a study (e.g., a resistance lines study, a triangulation study, a candlestick study, or a price patterns study), for the particular user-specified security. In step 332, the real-time results for the study may be displayed, for the particular user-specified security. In step 333, the order may be automatically submitted for execution, for the particular user-specified security, based on the results from the study reaching a pre-determined level.

FIG. 16: Price Patterns Study Window

FIG. 16 illustrates a price patterns study window 1600 according to one embodiment. The price patterns study window 1600 may include a series of candlesticks 1608, one for each time period. For more detail on candlesticks, refer to FIG. 11. As used herein, a “double bottom” is a price pattern that has four sections: a price dip, a price peak, another price dip, followed by a sharp break upward in price. As used herein, a “double top” is a price pattern that has four sections: a price peak, a price dip, another price peak, followed by a sharp break downward in price. Generally, a double bottom is considered a buy signal and a double top is considered a sell signal. Double bottoms 1601 and 1603 and double tops 1602, 1604, 1605, 1606, and 1607 may be identified.

The double bottom 1601 and the double top 1602 appear too early in the chart to be useful signals for the user to make a buy/sell decision. The double bottom 1603 is made up of a price dip in early July, a price peak in late July, another price dip in early August, followed by a sharp break upward in price on August 6. It is noted that no further double bottoms are shown in FIG. 16 because the candles do not dip lower than the August 6 price. The double top 1604 is made up of a price peak on August 11, a price dip on August 12, another price peak on August 16, followed by a sharp break downward in price on August 17. However, the double top 1604 is a weak signal because the prices start increasing at the next candle, August 18.

The double top 1605 is made up of a price peak on August 16, a price dip on August 20, another price peak on August 25, followed by a sharp break downward in price on August 26. The double top 1606 is made up of a price peak on August 31, a price dip on September 2, another price peak on September 6, followed by a sharp break downward in price on September 7. However, the double top 1606 is a weak signal, similar to the double top 1604. The double top 1607 is made up of a price peak on September 6, a price dip on September 7, another price peak on September 10, followed by a sharp break downward in price on September 13. It is noted that no further double tops are shown in FIG. 16, as the chart takes a downward turn from the local high that was reached on September 10.

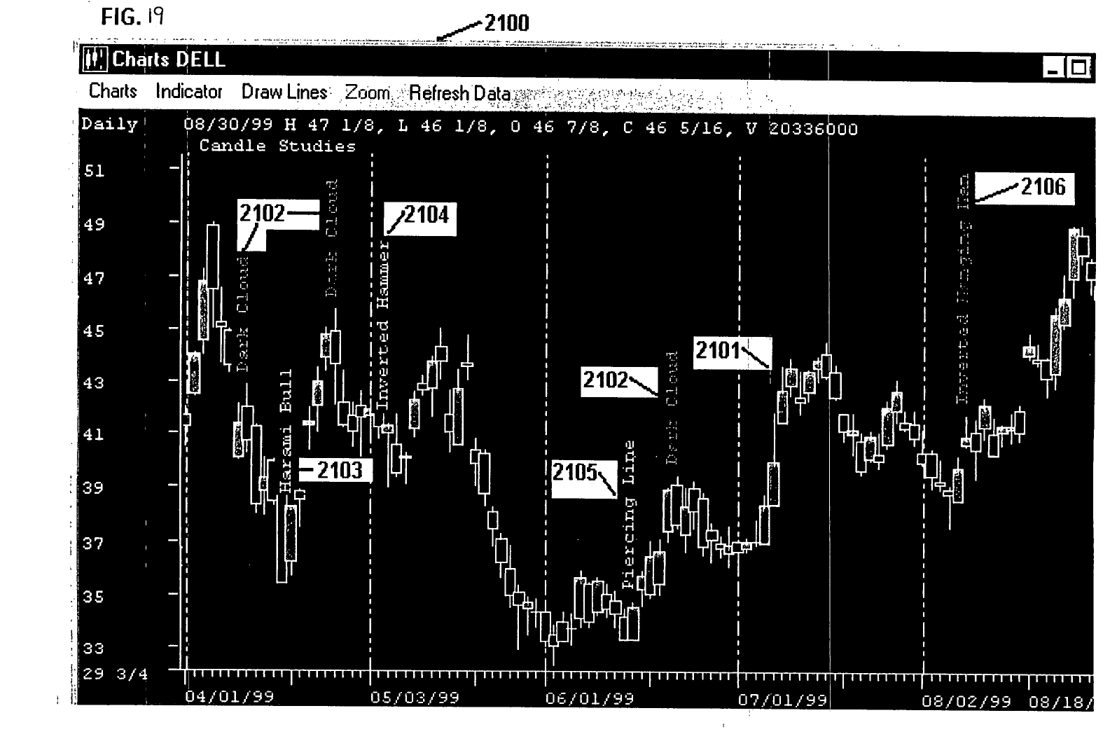

FIG. 19: Security-Specific Order Placement Window

FIG. 19 illustrates a security-specific order placement window 1900 according to one embodiment. The security-specific order placement window 1900 may be included within a view screen 155. The view screen 155 may be displayed on monitor 154, of FIG. 2. The security-specific order placement window 1900 may include one or more user interface elements, e.g., a security symbol 1901; a security transaction 1902 (which may be one of the following: buy, sell, sell short, stop loss, stop limit), and a list of order preferences 1903. Order preferences 1903 may be retrieved from the values stored on the order preferences window (see FIGS. 5 and 6) and may include a number of shares to be traded, a dollar amount, a limit price, a trailing stop price, and a stop loss price.

As shown in FIG. 19, the security symbol 1901 is “AOL”, which is the security symbol of America Online, Incorporated. The values in the list of order preferences 1903 are as follows: the number of shares is 100 shares, the dollar amount is $8,800, the limit price is $0, the trailing stop price is $0.125, and the stop loss price is $0. These order preferences 1903 values may be retrieved from values stored for the specific security (AOL) or from values stored for the generic security (DEFAULT) if no values were entered for AOL. These order preferences 1903 values may be modified by the user on the order placement window 1900. When the user is satisfied with the entries on the order placement window 1900, the user may then submit the order for execution by pressing the OK push-button 1904.

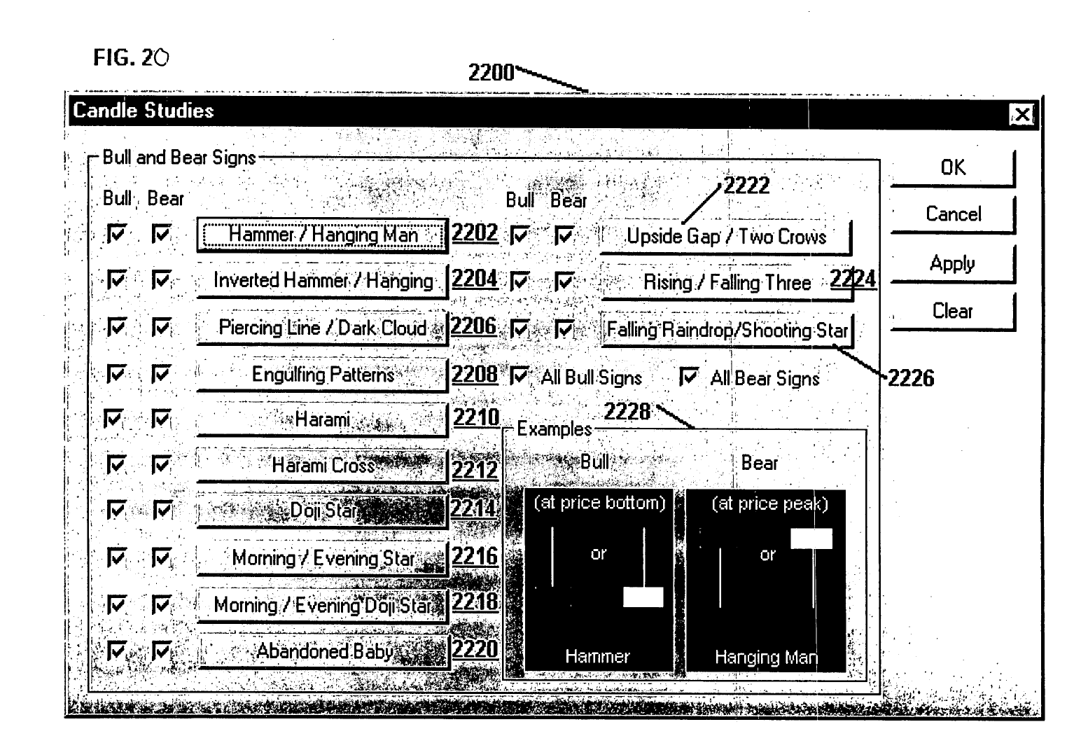

FIG. 20: Price Chart Window

FIG. 20 illustrates a price chart window 2000 according to one embodiment. The price chart window 2000 may include a security symbol 2001, a price range axis 2002, and a timestamp axis 2003. As shown in FIG. 20, the security symbol 2001 is “DELL”, which is the security symbol of Dell Computer Corporation. A series of candlesticks 2004, one for each time period, may be displayed. For more detail on candlesticks, refer to FIG. 11. One or more user-specified flags may be used to indicate a security transaction which the user would like performed on the security symbol 2001. These user-specified flags may each have one security transaction, chosen from the following: buy, sell, sell short, stop limit, and stop loss. As shown in FIG. 20, a buy security transaction flag 2005 is user-specified at a $39 15/16 price, a sell security transaction flag 2006 is user-specified at a $49 9/16 price, a sell short security transaction flag 2007 is user-specified at a $36 13/16 price, a stop limit security transaction flag 2008 is user-specified at a $47 price, and a stop loss security transaction flag 2009 is user-specified at a $34 ½ price. The price fluctuation of the security symbol 2001 may be monitored. In response to the user-specified price point being reached for any security transaction flag, an order for the security transaction for the security symbol 2001 is automatically submitted for execution. The dollar amount of the order may be retrieved from the lesser value of the two order preferences: number of shares to be traded and dollar amount (see FIGS. 5 and 6).

FIG. 21: Candle Studies Window

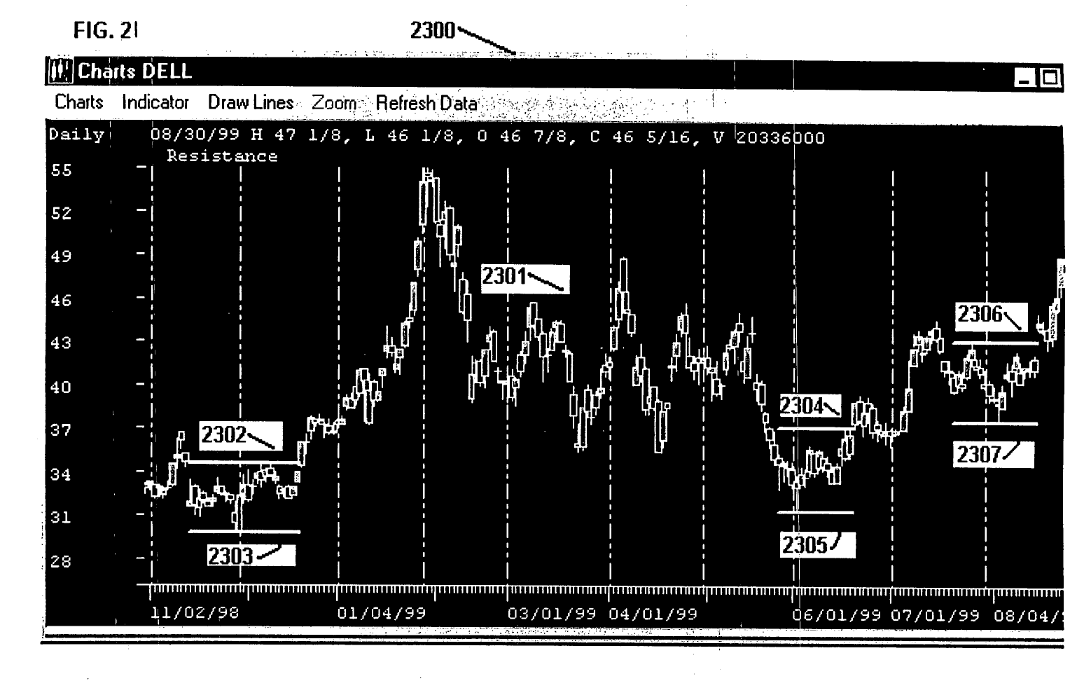

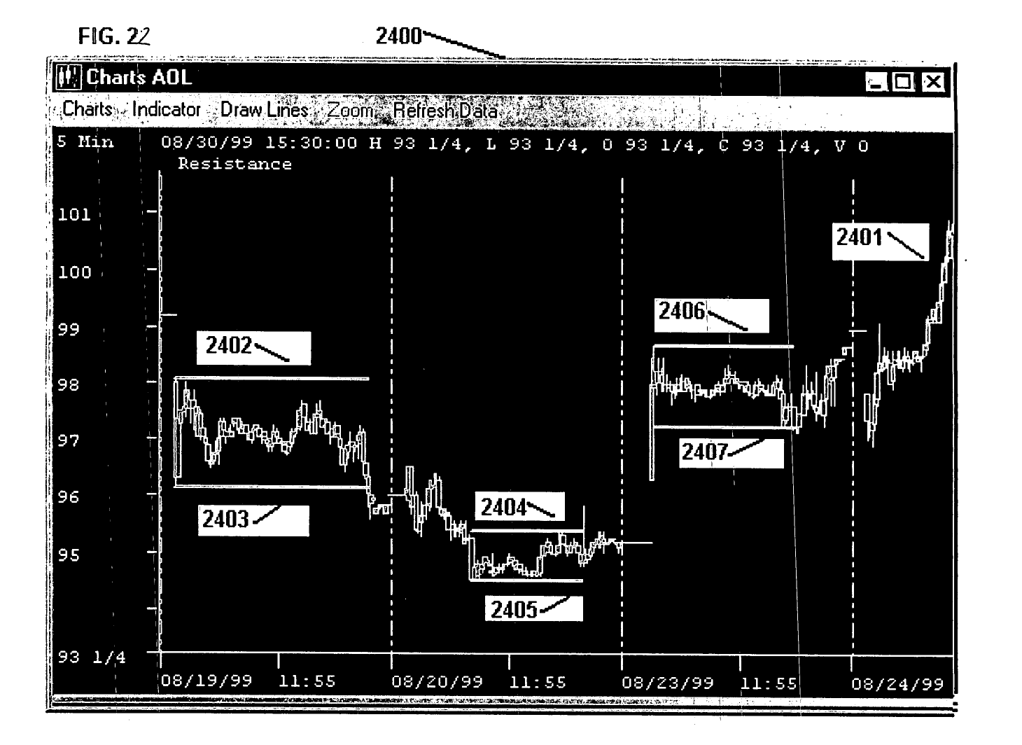

FIG. 21 illustrates a candle studies window 2100 according to one embodiment. The candle studies window 2100 may include a series of candlesticks 2101, one for each time period. Those candlesticks which form a particular pattern are labeled accordingly. As shown in FIG. 21, there are three dark clouds 2102, one harami bull 2103, one inverted hammer 2104, one piercing line 2105, and one inverted hanging man 2106. Refer to FIG. 22 for detailed descriptions of these and other candlestick formations.

FIG. 22: Parameter Window for the Candle Studies Window

FIG. 22 illustrates a parameter window 2200 for the candle studies window of FIG. 21 according to one embodiment. The parameter window 2200 may include a list of formations, such as hammer/hanging man 2202, inverted hammer/hanging man 2204, piercing line/dark cloud 2206, engulfing patterns 2208, harami 2210, harami cross 2212, doji star 2214, morning/evening star 2216, morning/evening doji star 2218, abandoned baby 2220, upside gap/two crows 2222, rising/falling three 2224, and falling raindrop/shooting star 2226. As shown in FIG. 22, the hammer/hanging man 2202 formation is highlighted, and the example box 2228 displays two sample formations: the first indicating a bull sign (hammer), the second indicating a bear sign (hanging man). Similarly, each of the other formations listed may show a bull and bear example candlestick in example box 2228 when highlighted. Each formation listed is further described below. It is important to note that identical candlesticks may have different meanings depending on where they occur within the context of prior trends and formations.

As used herein, a “hammer” is a candlestick with a long upper shadow and small real body. The upper shadow should be at least twice the length of the real body, and there should be no or very little lower shadow. The body may be either black or white. This candlestick occurs within the context of a downtrend to be considered a hammer.

As used herein, a “hanging man” is a candlestick with a long lower shadow and small real body. The lower shadow should be at least twice the length of the real body, and there should be no or very little upper shadow. The body may be either black or white. This candlestick occurs within the context of an uptrend to be considered a hanging man.

As used herein, an “inverted hammer” is a candlestick with a long lower shadow and small real body. The lower shadow should be at least twice the length of the real body, and there should be no or very little upper shadow. The body may be either black or white. This candlestick occurs within the context of a downtrend to be considered an inverted hammer.

As used herein, an “inverted hanging man” is a candlestick with a long upper shadow and small real body. The upper shadow should be at least twice the length of the real body, and there should be no or very little lower shadow. The body may be either black or white. This candlestick occurs within the context of an uptrend to be considered an inverted hanging man.

As used herein, a “piercing line” is a bullish signal, and is the opposite of a “dark cloud”. The first candlestick of the pattern consists of a black real body. The second candlestick consists of a long white real body. The second candlestick has an open price sharply lower, under the low price of the first candlestick. The second candlestick has a close price above the mid-point of the first candlestick's black real body. A “piercing line” formation occurs within a downtrend.

As used herein, a “dark cloud” is a bearish signal, and is the opposite of a “piercing line”. The first candlestick of the pattern consists of a strong white real body. The second candlestick has an open price above the top of the upper shadow of the first candlestick, but the close price of the second candlestick is at or near the low price of the second candlestick, and well into the first candlestick's white real body.

As used herein, a “bullish engulfing pattern” is a candlestick with a white real body totally covering, “engulfing” the prior day candlestick's real body. The market should be in a definable trend, not chopping around sideways. The shadows of the prior candlestick do not need to be engulfed.

As used herein, a “bearish engulfing pattern” is a candlestick with a black real body totally covering, “engulfing” the prior day candlestick's real body. The market should be in a definable trend, not chopping around sideways. The shadows of the prior candlestick do not need to be engulfed.

As used herein, a “harami” is the reverse of the engulfing pattern. The formation is comprised of two candlesticks. The first candlestick consists of a long real body. The second candlestick consists of a short real body of opposite color (e.g., if the long real body of the first candlestick is black, then the short real body of the second candlestick is white). The short real body of the second candlestick is completely within the long real body of the first candlestick.

As used herein, a “harami cross” is a harami pattern in which the second candlestick is a doji. The harami cross is an important reversal sign, especially if the first candlestick is in a downtrend.

As used herein, a “gap” is a significant price movement of a security between two trading sessions, such that there is no overlap in the trading ranges for the two days and that the second day's opening price is outside the first day's trading range, either above it or below it.

As used herein, a “star” is a candlestick formation consisting of a small real body that gaps away from the real body of the preceding candlestick. The real body of the star should not overlap the real body of the preceding candlestick. The color (e.g., white or black) of the star is not important, and a star may occur at either market tops or market bottoms.

As used herein, a “doji” is a candlestick which looks like a plus sign (“+”), represents the following: (i) the open price is equal to or very close to the close price, (ii) there is no real body, (iii) the high price is above the open price, and (iv) the low price is below the open price. The length of the upper shadow and the length of the lower shadow of a “doji” line may vary. For example a “doji” that looks like a dot (“.”), means that the open price is equal to or very close to the close price, the high price and the low price.

As used herein, a “doji star” is a doji which gaps above the previous candlestick's real body in an uptrend, or gaps below the previous candlestick's real body in a falling market. Two popular doji stars are the morning star and the evening star.

As used herein, a “morning star” is a bullish bottom reversal pattern, and is the opposite of an “evening star”. The formation is comprised of three candlesticks. The first candlestick consists of a tall black real body followed by the second candlestick having a small real body. The small real body of the second candlestick has a lower opening price than the first candlestick's real body (a star pattern). The third candlestick has a white real body that moves well into the first candlestick's black real body.

As used herein, an “evening star” is a bearish top reversal pattern, and is the opposite of a “morning star”. The formation is comprised of three candlesticks. The first candlestick consists of a long white real body. The second candlestick forms a star, followed by the third candlestick, which has a black real body that moves sharply into the first white candlestick.

As used herein, a “morning doji star” is a doji star in a downtrend, and is the opposite of an “evening doji star”. The formation is comprised of three candlesticks, with the morning doji star being the second candlestick. The third candlestick consists of a long white real body that closes well into the first candlestick's black real body. If the third candlestick is black and gapped lower, the bullishness of the doji is invalidated.

As used herein, an “evening doji star” is a doji star in an uptrend, and is the opposite of a “morning doji star”. The formation is comprised of three candlesticks, with the evening doji star being the second candlestick. The third candlestick consists of a long black real body that closes well into the first candlestick's white real body. If the third candlestick is white and gapped higher, the bearishness of the doji is invalidated.

As used herein, an “abandoned baby” is similar to the family of morning star and evening star patterns. It is almost the same as the morning doji star (e.g., a bullish abandoned baby) and the evening doji star (e.g., a bearish abandoned baby). The difference is the shadows on the doji gaps below the shadows of the first and third candlesticks for the abandoned baby bottom. The formation is comprised of three candlesticks, with the abandoned baby being the second candlestick. The third candlestick consists of a long real body that closes well into the first candlestick's real body. The first candlestick indicates the prior trend. The third candlestick is the opposite color of the first candlestick and gaps in the opposite direction. There are no shadows overlapping between the doji and the other two candlesticks.

As used herein, an “upside gap” is usually considered a bullish continuation sign. The formation is comprised of three candlesticks. The first and second candlesticks both have long white real bodies, with a gap between them. The third candlestick has a black real body that fills the gap between the first two candlesticks.

As used herein, a “two crows” is usually considered a bearish reversal sign. The formation is comprised of three candlesticks. The first candlestick has a long white real body. The second candlestick has a black real body that gaps above the first candlestick's real body. The third candlestick has a black real body that opens within the real body of the second candlestick and closes within the real body of the first candlestick.

As used herein, a “rising three” is usually considered a bullish continuation sign. The formation is comprised of five candlesticks. The first candlestick has a long white real body. The second, third, and fourth candlesticks have small real bodies and follow a brief downtrend pattern, but stay within the price range of the first candlestick. The fifth candlestick has a long white real body that closes above the close price of the first candlestick.

As used herein, a “falling three” is usually considered a bearish continuation sign. The formation is comprised of five candlesticks. The first candlestick has a long black real body. The second, third, and fourth candlesticks have small real bodies and follow a brief uptrend pattern, but stay within the price range of the first candlestick. The fifth candlestick has a long black real body that closes below the close price of the first candlestick.

As used herein, a “falling raindrop” is a candlestick with a small real body. The real body of the falling raindrop gaps below the real body of the previous candlestick.

As used herein, a “shooting star” is a candlestick with a small real body near the lower end of the trading range, with a long upper shadow. The real body of the shooting star gaps above the real body of the previous candlestick. The color (e.g., white or black) of the body of the shooting star is not critical. A shooting star is not usually considered a major bearish reversal sign, only a warning.

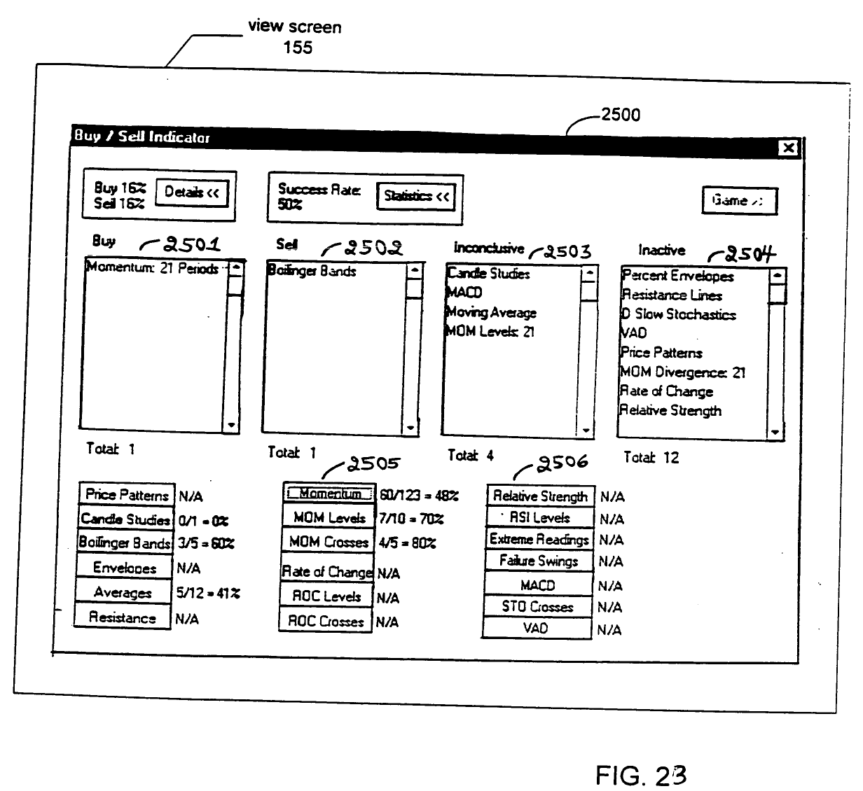

FIG. 23: Resistance Line Study Window—Daily

FIG. 23 illustrates a resistance line study (daily) window 2300 according to one embodiment. The graph on which the resistance lines are placed may be a candlestick study. A series of candlesticks 2301, one for each time period, may be displayed. For more detail on candlesticks, refer to FIG. 11. Upper resistance lines 2302, 2304, and 2306 and lower resistance lines 2303, 2305, and 2307 may be identified.

Each pair of resistance lines (e.g., 2302 and 2303, 2304 and 2305, 2306 and 2307) may be drawn on the graph in response to the patterns reaching at least a user-specified number of time periods. For more detail on user-specified parameters for resistance lines, refer to FIG. 10.

FIG. 24: Resistance Line Study Window—5 minute

FIG. 24 illustrates a resistance line study (5 minutes) window 2400 according to one embodiment. The graph on which the resistance lines are placed may be a candlestick study. A series of candlesticks 2401, one for each time period, may be displayed. For more detail on candlesticks, refer to FIG. 11. Upper resistance lines 2402, 2404, and 2406 and lower resistance lines 2403, 2405, and 2407 may be identified.

Each pair of resistance lines (e.g., 2402 and 2403, 2404 and 2405, 2406 and 2407) may be drawn on the graph in response to the patterns reaching at least a user-specified number of time periods. For more detail on user-specified parameters for resistance lines, refer to FIG. 10.

FIG. 25: Buy/Sell Indicator Window

FIG. 25 illustrates a buy/sell indicator window 2500 according to one embodiment. The buy/sell indicator window 2500 may be included within a view screen 155. The view screen 155 may be displayed on monitor 154, of FIG. 2. The buy/sell indicator window 2500 may include one or more categories, such as a buy category 2501, a sell category 2502, an inconclusive category 2503, and an inactive category 2504. For more detail on categories, refer to FIG. 13.

In one embodiment, a user would first select one or more studies from a list of studies for a particular user-specified security. Second, the user would enter one or more parameters for the user-selected studies. Third, as shown in FIG. 25, the real-time results of the user-selected studies for each security are displayed. The buy category 2501 may include the momentum:21 periods study. The sell category 2502 may include the bollinger bands study. The inconclusive category 2503 may include the following studies: candle, MACD, moving average, and MOM levels: 21. The inactive category 2504 may include the following studies: percent envelopes, resistance lines, D slow stochastics, VAD, price patterns, MOM divergence: 21, rate of change, and relative strength, which are all of the studies that were not selected by the user.

As shown in FIG. 25, below the categories, the name of each study available to the user is listed followed by either “N/A” or a ratio (e.g., “60/123=48%”). For example, the relative strength 2506 study is followed by “N/A”. It is noted that the name of each study in the inactive category 2504, may be followed by “N/A”, indicating that its ratio is not applicable in this instance. For each study included in the buy category 2501, the sell category 2502, and the inconclusive category 2503, the ratio of the number of profitable buy/sell signals to the total number of buy/sell signals for the past history time period may be displayed. For example, the momentum 2505 study is followed by “60/123=48%”, meaning that 60 of the 123 total number of buy signals for the past history time period were profitable. The 48% is the result of dividing 60 by 123, and truncating after two decimal points.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1-80. (canceled)

81. A method for allowing relatively rapid entry of securities orders into a computer system, the method comprising:
presenting a list of studies to a user, wherein each study comprises a different method of analyzing historical securities data;
allowing the user to select one or more of the studies from the list for a particular user-specified security;
prompting the user to enter one or more parameters for the user-selected studies; and
displaying real-time results of the user-selected studies for each security.

82. The method of claim 81, further comprising submitting an order for execution based on the real-time results.

83. The method of claim 81, wherein the list of studies comprises a resistance lines study and a triangulation study.

84. The method of claim 81, wherein the list of studies comprises a resistance lines study, and wherein the resistance lines study comprises a study that identifies patterns, and wherein the patterns indicate a price of a security moving between an upper level and a lower level, and wherein a distance between the upper level and the lower level is user-specified, and wherein an acceptable range for the pattern above the upper level and below the lower level is user-specified, and wherein the patterns are identified in response to the patterns reaching at least a user-specified number of time periods, and wherein the patterns are identified in response to the patterns falling within the acceptable range above the upper level and below the lower level, and wherein the patterns are identified with two straight lines.

85. The method of claim 81, wherein the list of studies comprises a triangulation study, and wherein the triangulation study comprises a study that identifies patterns, and wherein the patterns indicate a price of a security moving between an upper level and a lower level, and wherein the distance between the upper level and the lower level is user-specified, and wherein an acceptable range for the pattern above the upper level and below the lower level is user-specified, and wherein the patterns are identified in response to the patterns reaching at least a user-specified number of time periods, and wherein the patterns are identified in response to the patterns falling within the acceptable range above the upper level and below the lower level, and wherein the patterns are identified with two sloped lines.

86. The method of claim 81, wherein the list of studies comprises a candlestick study.

87. The method of claim 86, wherein the candlestick study comprises a graph plotting an open price, a close price, a high price, and a low price for a security for a user-specified time period; and wherein the graph indicates a bullish signal in response to the closing price being greater than the opening price; and wherein the graph indicates a bearish signal in response to the closing price being equal to or lower than the opening price.

88. The method of claim 81, wherein the list of studies comprises a price patterns study.

89. The method of claim 81, wherein the price patterns study comprises a study that identifies double bottoms and double tops on a graph on which closing prices for a security are plotted for a user-specified time period, and wherein a double bottom indicates a bullish signal, and wherein a double top indicates a bearish signal.

90. The method of claim 81, further comprising:
(a) presenting a study details window for each security to the user, wherein the study details window further comprises:
a means for allowing the user to specify one or more of the parameters, wherein the parameters are determined by each study;
a means for allowing the user to specify a past history time period;
a means for allowing the user to specify a threshold; and
(b) presenting default values for each of the parameters, the past history time period, and the threshold for each study;
(c) allowing the user to adjust one or more of the default values; and
repeating (a), (b), and (c) for each study selected.

91. The method of claim 81, further comprising:
distributing each study in the list of studies into one of a plurality of categories, where the categories comprise a buy category, a sell category, an inconclusive category, and an inactive category;
wherein the buy category comprises user-selected studies for which a ratio of a number of profitable buy signals to a total number of buy signals for a past history time period reaches or exceeds a threshold;
wherein the sell category comprises user-selected studies for which a ratio of a number of profitable sell signals to a total number of sell signals for the past history time period reaches or exceeds a threshold;
wherein the inconclusive category comprises user-selected studies for which both a buy signal ratio and a sell signal ratio fall below their respective thresholds; and
wherein the inactive category comprises those studies which were not user-selected.

92. The method of claim 91, wherein a ratio of a number of profitable buy or sell signals to a total number of buy or sell signals for the past history time period for each of the user-selected studies is displayed.

93. The method of claim 91, wherein a ratio of a number of profitable buy or sell signals to a total number of buy or sell signals for the past history time period for each of the user-selected studies is used to determine whether or not to submit an order for execution for a user-specified security.

94. The method of claim 93, further comprising:
detecting a user-specified security transaction flag option for a user-specified price point for one or more securities;
monitoring a price fluctuation of a user-specified security;
determining when the user-specified price point is reached for the user-specified security; and
submitting an order for execution for the user-specified security in response to the user-specified price point for the security being reached.

95. The method of claim 81, wherein the computer system is coupled to a computer network.

96. The method of claim 95, wherein the computer network comprises the Internet.

97. A system comprising:
a network;
a CPU coupled to the network;
a system memory coupled to the CPU, wherein the system memory comprises program instructions executable to implement:
presenting a list of studies to a user, wherein each study comprises a different method of analyzing historical securities data;
allowing the user to select one or more of the studies from the list for a particular user-specified security;
prompting the user to enter one or more parameters for the user-selected studies; and
displaying real-time results of the user-selected studies for each security.

98. A carrier medium comprising program instructions, wherein the program instructions are executable to implement:
presenting a list of studies to a user, wherein each study comprises a different
method of analyzing historical securities data;
allowing the user to select one or more of the studies from the list for a particular user-specified security;
prompting the user to enter one or more parameters for the user-selected studies; and
displaying real-time results of the user-selected studies for each security.
